(19) United States
(12) Patent Application Publication
(10) Pub. No.: US 2005/0054329 A1
(43) Pub. Date: Mar. 10, 2005

(54) Wireless network registration system and wireless network registration method thereof

(75) Inventor: Junichi Kokudo, Tokyo (JP)

Correspondence Address: OSTROLENK FABER GERB & SOFFEN, 1180 AVENUE OF THE AMERICAS, NEW YORK, NY, 100368403, US

(73) Assignee: NEC Corporation

(21) Appl. No.: 10/938,984

(22) Filed: Sep. 10, 2004

(30) Foreign Application Priority Data
Sep. 10, 2003 (JP) 317614/2003

(51) Int. Cl. H04M 1/66; H04M 3/16; H04M 1/00

(52) U.S. Cl. 455/411; 455/410; 455/558

(57) ABSTRACT

It is an object of the present invention to provide a wireless network registration system which eliminates manual labor with respect to registration of a wireless connection apparatus with a wireless network, and in which setting may be executed very easily without making any errors even by people of a wide variety of ages or conditions to be targeted for a home electric appliance. A network management apparatus is connected to a wireless network through a wireless access point, and has address information, authentication information, encryption key information and the like for a wireless connection apparatus to be connected to the wireless network. An IC card reader-writer apparatus communicates with the network management apparatus or the wireless connection apparatus by means of a non-contact type IC card interface, and reads out the address information, the authentication information, the encryption key information and the like from the network management apparatus, and writes and sets the information into the wireless connection apparatus.

### BACKGROUND OF THE INVENTION

1. Field of the Invention

The present invention relates to a wireless network registration system and a wireless network registration method thereof, and more particularly to a method for additionally registering a wireless connection apparatus with a wireless network.

2. Related Art

Conventionally, in a wireless network registration system, as shown in FIG. 11, a network management apparatus 5 manages a wireless access point 6 within a wireless network 200.

In other words, the network management apparatus 5 is a router device, a hub device or a server device, and manages registration and connection of a wireless connection apparatus 7 to the wireless network 200 by managing the wireless access point 6. The wireless access point 6 connects wirelessly to the wireless connection apparatus 7, and connects the wireless connection apparatus 7 to an external network such as the Internet.

If the wireless connection apparatus 7 is to be additionally registered with the wireless network 200, address information, authentication information, encryption key information and the like, which will be required for the wireless connection apparatus 7, are set with respect to the wireless connection apparatus 7. These settings are executed manually, or executed with a PC (personal computer) or the like by reading a file or the like (for example, refer to Japanese Patent Laid-Open No. 2003-91467).

However in the conventional wireless network registration system, if a large variety of settings are inputted manually into the wireless connection apparatus for the address information, the authentication information, the encryption key information and the like, there are several problems in that the settings are not only very time-consuming but also may be erroneous, and that primarily the settings are impossible without any expertise with respect to the settings of the wireless network.

Moreover, in the conventional wireless network registration system, if the settings of the wireless connection apparatus are to be omitted by using uniquely defined setting information instead of using these address information, the authentication information, the encryption key information and the like, it may be very easy for others to intercept the information communicated in the wireless network, ant there is an problem in that safety of the communication may not be assured.

Furthermore, in the conventional wireless network registration system, if the wireless connection apparatus is a home electric appliance or the like, even though the apparatus may be connected to the PC or the like, it may not be operated without any problem by people of a wide variety of ages or conditions to be targeted for the home electric appliance because of necessity of high expertise for PC operation.

### BRIEF SUMMARY OF THE INVENTION

Therefore, it is an object of the present invention to solve the above described problems and to provide a wireless network registration system and a wireless network registration method thereof, which eliminates manual labor with respect to registration of a wireless connection apparatus with a wireless network, and in which setting may be executed very easily without making any errors by people of a wide variety of ages or conditions to be targeted for a home electric appliance.

Moreover, it is another object of the present invention to provide a wireless network registration system and a wireless network registration method thereof, in which a necessary data format may be adjusted even though a write-setting format of the wireless connection apparatus varies across models thereof.

A wireless network registration system according to the present invention is a wireless network registration system for registering a wireless connection apparatus with a wireless network, including: a network management apparatus for managing setting information on the wireless connection apparatus; and means passing the setting information stored in the network management apparatus to the wireless connection apparatus by means of a non-contact type IC card interface.

In the wireless network registration system, the means passing the setting information is included in an IC card reader-writer apparatus provided independently from the network management apparatus and the wireless connection apparatus; and
means acquiring a write-setting format of the wireless connection apparatus via the Internet is included in the IC card reader-writer apparatus, and the IC card reader-writer apparatus writes the setting information to the wireless connection apparatus based on the write-setting format.

A wireless network registration method according to the present invention is a wireless network registration method for registering a wireless connection apparatus with a wireless network, wherein setting information stored in a network management apparatus for managing the setting information on the wireless connection apparatus is passed to the wireless connection apparatus by means of a non-contact type IC card interface.

In the wireless network registration method, the passing of the setting information is executed by means of an IC card reader-writer apparatus provided independently from the network management apparatus and the wireless connection apparatus; and the IC card reader-writer apparatus acquires a write-setting format of the wireless connection apparatus via the Internet, and writes the setting information to the wireless connection apparatus based on the write-setting format.

In other words, the wireless network registration system of the present invention relates to the wireless network used at home or in a small office, and is provided with a network management apparatus, such as a router device, a hub device or a server device, for managing and controlling the wireless network; and a wireless connection apparatus to be registered with the wireless network.

In the wireless network registration system of the present invention, each of the network management apparatus and the wireless connection apparatus has a non-contact type IC card interface for performing proximity communication wirelessly. The IC card reader-writer apparatus reads address information, authentication information, encryption key information and the like, which are required for connecting to the network, from the network management apparatus, and then writes and sets the information into the wireless connection apparatus to be registered.

Thereby, in the wireless network registration system of the present invention, it may be possible to execute the setting of the wireless connection apparatus to be newly registered, quickly without any expertise, and also to additionally register and use the wireless connection apparatus easily.

Moreover, in the wireless network registration system of the present invention, the IC card reader-writer apparatus is embedded in a cellular phone or connected to the Internet through a cellular network, a wired LAN (Local Area Network), a wireless LAN or the like, so that a server indicating the setting format of the wireless connection apparatus to be connected to the wireless network used at home or in the small office may be accessible.

In this case, even though the write-setting format of the wireless connection apparatus varies across the models thereof, it may be possible for the IC card reader-writer apparatus to adjust the necessary data format, and to write and set the information into the wireless connection apparatus based on the format.

Furthermore, in the wireless network registration system of the present invention, the network management apparatus, such as the router device, the hub device or the server device, for managing and controlling the wireless network, has the non-contact type IC card interface, and it may be possible to additionally register and use the wireless connection apparatus easily by writing and setting the address information, authentication information, encryption key information and the like which are required for connecting to the network, with respect to the wireless connection apparatus to be additionally registered, directly from the network management apparatus through the IC card interface.

### BRIEF DESCRIPTION OF THE DRAWINGS

FIG. 1 is a block diagram showing a configuration of a wireless network registration system according to a first embodiment of the present invention;

FIG. 2 is a block diagram showing a configuration of a network management apparatus according to the first embodiment of the present invention;

FIG. 3 is a block diagram showing a configuration of a wireless access point according to the first embodiment of the present invention;

FIG. 4 is a block diagram showing a configuration of a wireless connection apparatus according to the first embodiment of the present invention;

FIG. 5 is a block diagram showing a configuration of an IC card reader-writer apparatus according to the first embodiment of the present invention;

FIG. 6 is a sequence chart showing an operation of the wireless network registration system according to the first embodiment of the present invention;

FIG. 7 is a block diagram showing the configuration of the IC card reader-writer apparatus according to a second embodiment of the present invention;

FIG. 8 is a sequence chart showing the operation of the wireless network registration system according to the second embodiment of the present invention;

FIG. 9 is a block diagram showing the configuration of the network management apparatus according to a third embodiment of the present invention;

FIG. 10 is a sequence chart showing the operation of the wireless network registration system according to the third embodiment of the present invention; and

FIG. 11 is a block diagram showing the configuration of a conventional wireless network registration system.

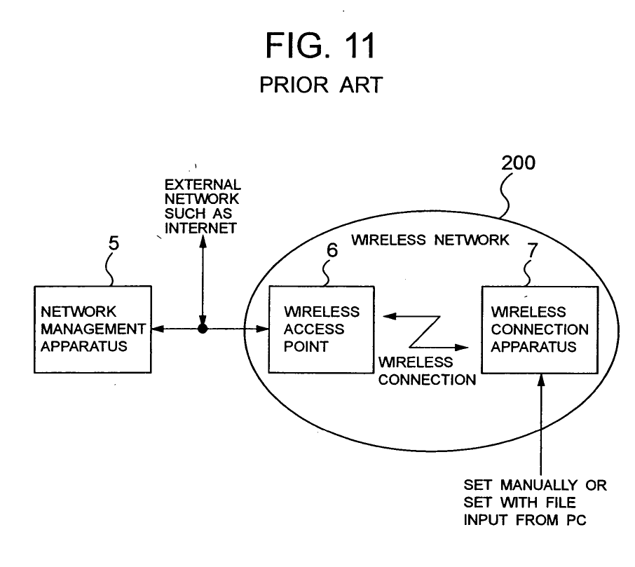

### DETAILED DESCRIPTION OF THE PREFERRED EMBODIMENTS

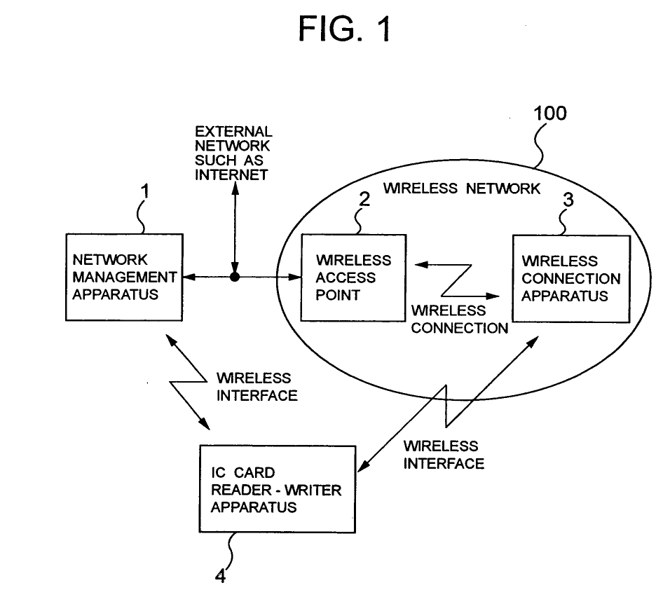

Next, embodiments of the present invention will be described with reference to the drawings. FIG. 1 is a block diagram showing a configuration of a wireless network registration system according to the first embodiment of the present invention. In FIG. 1, the wireless network registration system according to the first embodiment of the present invention includes a network management apparatus 1, a wireless network 100 including a wireless access point 2 and a wireless connection apparatus 3, and an IC (integrated circuit) card reader-writer apparatus 4.

The network management apparatus 1 is installed at home or in a small office in order to manage the wireless network 100. The network management apparatus 1 manages address assignment of the wireless connection apparatus 3 to be connected to the wireless network 100, connection authentication with respect to the apparatus to be connected, and encryption keys for encryption communication. The network management apparatus 1 is connected to the wireless network 100 through the wireless access point 2, and has address information, authentication information, encryption key information and the like for the wireless connection apparatus 3 to be connected to the wireless network 100.

Only if the wireless connection apparatus 3 has been set completely for connecting legally with respect to the wireless network 100, it may be connected wirelessly to the wireless access point 2 (encryption communication), and also may participate in the wireless network 100.

The IC card reader-writer apparatus 4 communicates with the network management apparatus 1 or the wireless connection apparatus 3, though in a proximity communication using a wireless communication [for example, IEEE (Institute of Electrical and Electronics Engineers) 802.11a, IEEE802.11b, IEEE802.11g, Bluetooth and the like], by means of a non-contact type IC card interface, and thus may read out the address information, the authentication information, the encryption key information and the like, which are managed in the network management apparatus 1, therefrom or may write and set the information into the wireless connection apparatus 3.

There is the case where the IC card reader-writer apparatus 4 maybe connected to a server apparatus (not shown) on the Internet through a cellular network, a wired LAN (Local Area Network), a wireless LAN or the like.

Moreover, there is the case where the network management apparatus 1 has a non-contact type IC card interface in itself, and may write and set the address information, the authentication information and the encryption key information directly with respect to the wireless connection apparatus 3 without the IC card reader-writer apparatus 4.

Thus, in the first embodiment of the present invention, in the wireless network 100 used at home or in the small office, it is possible to execute setting of the wireless connection apparatus 3 to be newly registered, quickly without any expertise, and also to additionally register and use the wireless connection apparatus 3 easily, by reading out easily the setting information, which is held in the network management apparatus 1 for managing and controlling the wireless network 100 and is necessary for a wireless connection, by means of the IC card reader-writer apparatus 4 having the IC card interface, and then writing and setting the information into the wireless connection apparatus 3.

Moreover, in the first embodiment of the present invention, if the IC card reader-writer apparatus 4 is connected to the Internet through a public network such as the cellular network, it is possible to additionally register the wireless connection apparatus 3 easily even though a write-setting format of the wireless connection apparatus 3 varies across models thereof.

Furthermore, in the first embodiment of the present invention, if the network management apparatus 1 has the IC card interface in itself, it may be possible to set the wireless connection apparatus 3 directly without using the IC card reader-writer apparatus 4.

The network management apparatus 1, the wireless access point 2, the wireless connection apparatus 3 and the IC card reader-writer apparatus 4, which are principal components of the wireless network registration system according to the first embodiment of the present invention, will be described below.

The network management apparatus 1, which is an apparatus such as a router device, a hub device or a server device for managing and controlling the network, is connected to the wireless access point 2 through an Ethernet or the like. Also the network management apparatus 1 may connect to the IC card reader-writer apparatus 4 by means of a wireless interface which is the non-contact type IC card interface, and may send the address information, the authentication information, the encryption key information and the like necessary for connecting to the wireless network 100, to the IC card reader-writer apparatus 4.

The wireless access point 2 is connected to the network management apparatus 1 through the Ethernet or the like, and also connected to the wireless connection apparatus 3 through a wireless LAN or the like, and configures the wireless network 100 used at home or in the small office. Moreover, the wireless access point 2 has a function in which the wireless connection apparatus 3 may connect to other wireless connection apparatus, the Internet or the like through the access point 2.

The wireless connection apparatus 3 is connected to the wireless access point 2 through the wireless LAN or the like, and connects to the wireless network 100 through the wireless access point 2, when a network connection is required for functions included in the wireless connection apparatus 3, for example, such as a personal computer function, a television function, an audio function, a home electric appliance function and the like. Also, the wireless connection apparatus 3 may connect to the IC card reader-writer apparatus 4 by means of the wireless interface which is the non-contact type IC card interface, and may receive the address information, the authentication information, the encryption key information and the like necessary for connecting to the wireless network 100, from the IC card reader-writer apparatus 4.

The IC card reader-writer apparatus 4 may connect to the network management apparatus 1 and the wireless connection apparatus 3 by means of the wireless interface which is the non-contact type IC card interface, and may send the address information, the authentication information, the encryption key information and the like, which has been received from the network management apparatus 1, to the wireless connection apparatus 3.

Moreover, the IC card reader-writer apparatus 4 has, for example, an Internet connection unit for connecting to the Internet through the public network such as the cellular network, and thus it is possible to additionally register the wireless connection apparatus 3 easily even though the write-setting format of the wireless connection apparatus 3 varies across the models thereof, by informing the server (not shown) placed on the Internet of the model of the wireless connection apparatus 3 and obtaining the format to be set to the wireless connection apparatus 3.

On the other hand, if the network management apparatus 1 has an IC card reader-writer unit in itself, it may set the wireless connection apparatus 3 directly without using the IC card reader-writer apparatus 4.

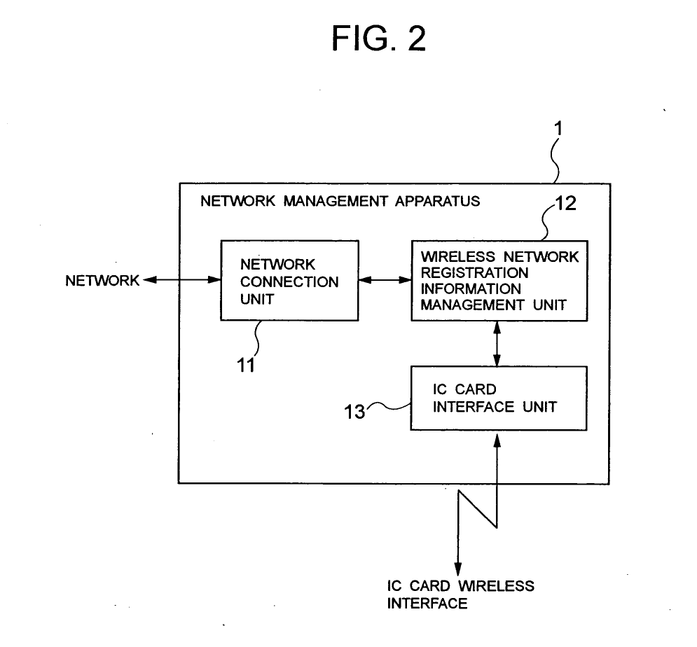

FIG. 2 is a block diagram showing a configuration of the network management apparatus 1 according to the first embodiment of the present invention. In FIG. 2, the network management apparatus 1 includes a network connection unit 11, a wireless network registration information management unit 12, and an IC card interface unit 13.

The network connection unit 11 connects the network management apparatus 1 to the wireless access point 2 and an external network such as the Internet, through the Ethernet or the like. The wireless network registration information management unit 12 manages the address, the authentication information, the encryption key and the like of the wireless connection apparatus 3 to be connected to the wireless network 100 through the wireless access point 2. The IC card interface unit 13 reads and writes the managed information by means of the non-contact type IC card interface.

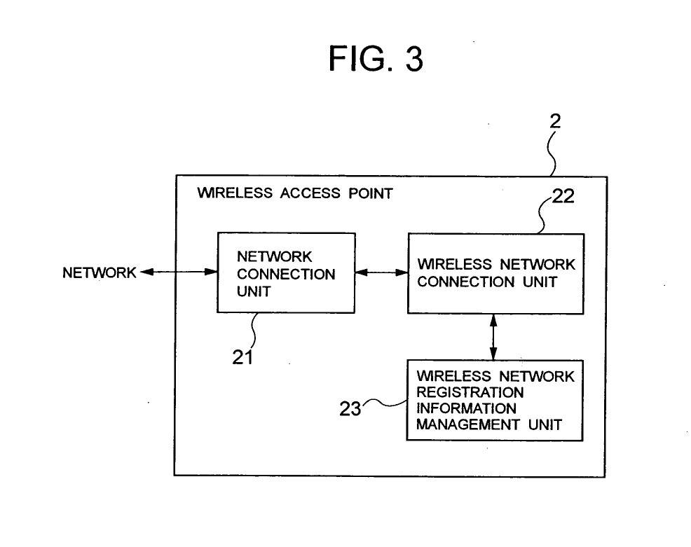

FIG. 3 is a block diagram showing a configuration of the wireless access point 2 according to the first embodiment of the present invention. In FIG. 3, the wireless access point 2 includes a network connection unit 21, a wireless network connection unit 22 and a wireless network registration information management unit 23.

The network connection unit 21 connects the wireless access point 2 to the network management apparatus 1 and the external network such as the Internet, through the Ethernet or the like. The wireless network connection unit 22 connects wirelessly the wireless access point 2 to the wireless network 100 including the wireless connection apparatus 3 and the like, by means of the wireless LAN or the like. The wireless network registration information management unit 23 manages the address, the authentication information, the encryption key and the like required for executing the wireless connection by the wireless connection apparatus 3 and the like.

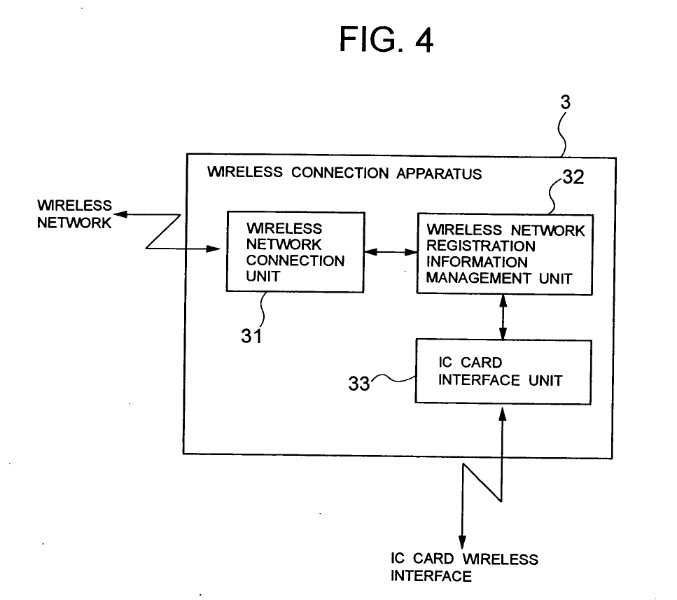

FIG. 4 is a block diagram showing a configuration of the wireless connection apparatus 3 according to the first embodiment of the present invention. In FIG. 4, the wireless connection apparatus 3 includes a wireless network connection unit 31, a wireless network registration information management unit 32 and an IC card interface unit 33.

The wireless network connection unit 31 connects wirelessly the wireless connection apparatus 3 to the wireless access point 2 with the wireless LAN or the like. The wireless network registration information management unit 32 manages the address, the authentication information, the encryption key and the like of a wireless apparatus to be connected to the wireless network 100. The IC card interface unit 33 reads and writes the managed information by means of a wireless tag interface which is the non-contact type IC card interface.

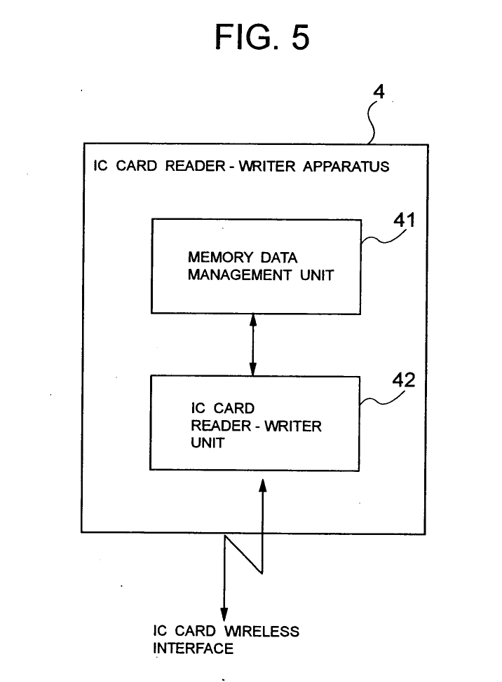

FIG. 5 is a block diagram showing a configuration of the IC card reader-writer apparatus 4 according to the first embodiment of the present invention. In FIG. 5, the IC card reader-writer apparatus 4 includes a memory data management unit 41 and an IC card reader-writer unit 42.

The memory data management unit 41 stores and manages the address, an ID (identification information), an authentication code, the encryption key and the like of the wireless connection apparatus 3. The IC card reader-writer unit 42 reads and writes the above described data by means of the wireless interface which is the non-contact type IC card interface.

Though the network management apparatus 1, the wireless access point 2, the wireless connection apparatus 3 and the IC card reader-writer apparatus 4, which are the principal components of the wireless network registration system according to the first embodiment of the present invention, have been described above, since the external network such as the Internet is well known to those skilled in the art and is not related directly to the present invention, description of a configuration of the external network will be omitted.

It should be noted that, though the network management apparatus 1 and the wireless access point 2 are described individually in the first embodiment, they may be arranged together as a network management apparatus having a built-in wireless access point. Moreover, the IC card reader-writer apparatus 4 may be configured to be included in a cellular apparatus such as a cellular phone terminal.

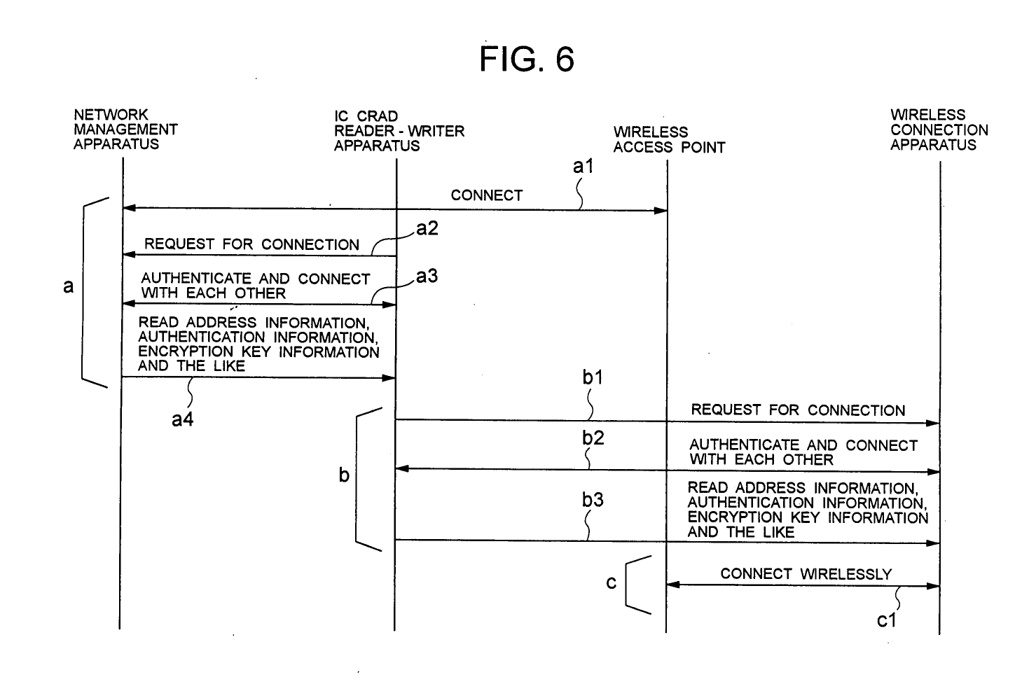

FIG. 6 is a sequence chart showing an operation of the wireless network registration system according to the first embodiment of the present invention. With reference to these FIGS. 1 to 6, the operation of the wireless network registration system according to the first embodiment of the present invention will be described below.

The wireless network registration system according to the first embodiment relates to the wireless network 100 used at home or in the small office, as described above, and includes the network management apparatus 1 such as the router device, the hub device or the server device, for managing and controlling the wireless network 100, and the wireless connection apparatus 3 to be registered with the wireless network 100.

Moreover, in the first embodiment, each of the network management apparatus 1 and the wireless connection apparatus 3 has the non-contact type IC card interface. The IC card reader-writer apparatus 4 reads out the address information, the authentication information, the encryption key information and the like, which are required for connecting to the wireless network 100, from the network management apparatus 1, and then writes and sets the information into the wireless connection apparatus 3 to be newly registered.

Thereby, in the first embodiment, it is possible to execute the setting of the wireless connection apparatus 3 to be newly registered, quickly without any expertise, and also to additionally register and use the wireless connection apparatus 3 easily.

In the first embodiment, if the IC card reader-writer apparatus 4 is moved close to the network management apparatus 1 to read out the various information such as the address information, the authentication information, the encryption key information and the like, the IC card reader-writer apparatus 4 and the network management apparatus 1 are authenticated mutually and connected with each other (a3 in FIG. 6) by the IC card reader-writer apparatus 4 executing a request for connection to the network management apparatus 1 (a2 in FIG. 6).

Subsequently, the IC card reader-writer apparatus 4 reads the various information from the network management apparatus 1 (a4 in FIG. 6) [see (a) in FIG. 6]. In this case, the network management apparatus 1 and the wireless access point 2 are connected with each other (a1 in FIG. 6).

If IC card reader-writer apparatus 4 with the above described various information written therein, is moved close to the wireless connection apparatus 3 to be registered and connected to the wireless network 100, the IC card reader-writer apparatus 4 and the wireless connection apparatus 3 are authenticated mutually and connected with each other (b2 in FIG. 6) by the IC card reader-writer apparatus 4 executing the request for connection to the wireless connection apparatus 3 (b1 in FIG. 6). Subsequently, the IC card reader-writer apparatus 4 writes the various information, which has been written in itself, with respect to the wireless connection apparatus 3 (b3 in FIG. 6) [see (b) in FIG. 6].

Accordingly, since the wireless connection apparatus 3 may complete registration setting and the authentication with respect to the wireless access point 2 by means of the various information written from the IC card reader-writer apparatus 4, it is registered and connected to the wireless network 100 (c1 in FIG. 6) [see (c) in FIG. 6].

Thus, in the first embodiment, since the wireless connection apparatus 3 receives from the IC card reader-writer apparatus 4 the address information, the authentication information, the encryption key information and the like, which are required when the wireless connection apparatus 3 is to be registered and connected to the wireless network 100, into the wireless connection apparatus 3, it is possible to register and set the wireless connection apparatus 3 to the wireless network 100 easily without any expertise specific to the wireless network, without making any errors or becoming anxious due to the connection by means of a connector and the like, or without having the setting information intercepted by others.

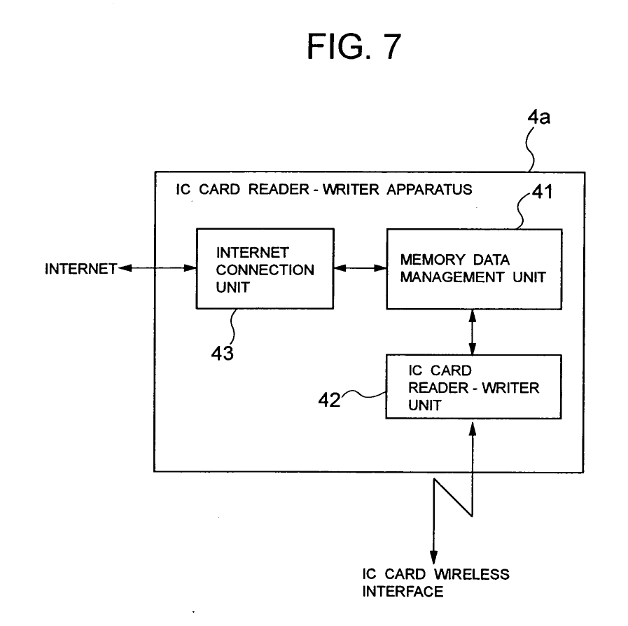

FIG. 7 is a block diagram showing the configuration of an IC card reader-writer apparatus according to the second embodiment of the present invention. In FIG. 7, an IC card reader-writer apparatus 4a according to the second embodiment of the present invention has a similar configuration as the IC card reader-writer apparatus 4 according to the first embodiment of the present invention as shown in FIG. 5, except that the IC card reader-writer apparatus 4a is provided with an internet connection unit 43 for connecting the apparatus 4a to the Internet through the cellular network or connecting the apparatus 4a to the network through the wired LAN, the wireless LAN or the like. Thus the same components are numbered with the same reference numerals.

It should be noted that the wireless network registration system according to the second embodiment of the present invention is similar as the first embodiment of the present invention, and the configurations of the principal components of the wireless network registration system are also similar as the first embodiment of the present invention, except for the IC card reader-writer apparatus 4a.

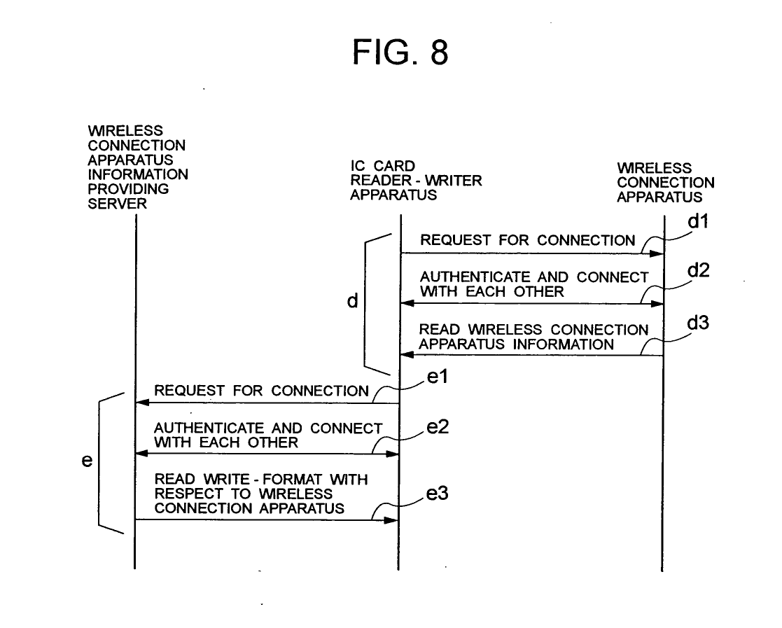

FIG. 8 is a sequence chart showing the operation of the wireless network registration system according to the second embodiment of the present invention. With reference to FIG. 8, the operation of the wireless network registration system according to the second embodiment of the present invention will be described below.

In this case, prior to the sequence (a) shown in FIG. 6, if the IC card reader-writer apparatus 4a is moved close to the wireless connection apparatus 3 to be registered and connected to the wireless network 100, the IC card reader-writer apparatus 4a and the wireless connection apparatus 3 are authenticated mutually and connected with each other (d2 in FIG. 8) by the IC card reader-writer apparatus 4a executing the request for connection to the wireless connection apparatus 3 (d1 in FIG. 8). Subsequently, the IC card reader-writer apparatus 4a reads the wireless connection apparatus information from the wireless connection apparatus 3 (d3 in FIG. 8) [see (d) in FIG. 8].

Once the IC card reader-writer apparatus 4a reads the wireless connection apparatus information, it connects to a wireless connection apparatus information providing server through the Internet (e1 and e2 in FIG. 8) to receive a write-format with respect to the wireless connection apparatus 3 from the wireless connection apparatus information providing server (e3 in FIG. 8) [see (e) in FIG. 8]. The IC card reader-writer apparatus 4a executes the sequence shown in FIG. 6, based on the write-format. Therefore, the wireless connection apparatus 3 is registered and connected to the wireless network 100.

Thus, in the second embodiment, if an IC card reader-writer apparatus may be embedded in the cellular phone or connected to the Internet through the public network such as the cellular network, even though the write-setting format of the wireless connection apparatus 3 varies across the models thereof, it is possible to adjust a necessary data format by receiving information on the write-setting format of the wireless connection apparatus 3 from the server on the Internet.

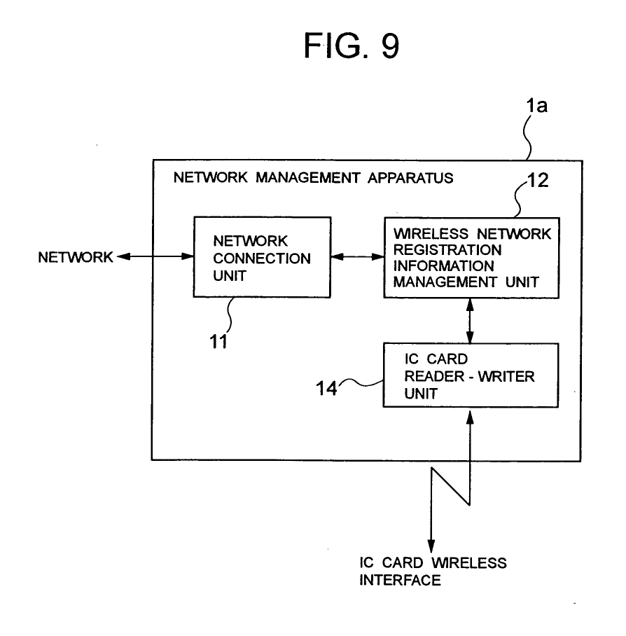

FIG. 9 is a block diagram showing the configuration of a network management apparatus according to the third embodiment of the present invention. In FIG. 9, the network management apparatus 1a according to the third embodiment of the present invention has a similar configuration as the network management apparatus 1 according to the first embodiment of the present invention as shown in FIG. 2, except that the network management apparatus 1a is provided with an IC card reader-writer unit 14 instead of the IC card interface unit 13. Thus the same components are numbered with the same reference numerals.

It should be noted that the wireless network registration system according to the third embodiment of the present invention is similar as the first embodiment of the present invention, and the configurations of the principal components of the wireless network registration system are similar as the first embodiment of the present invention, except for the network management apparatus 1a.

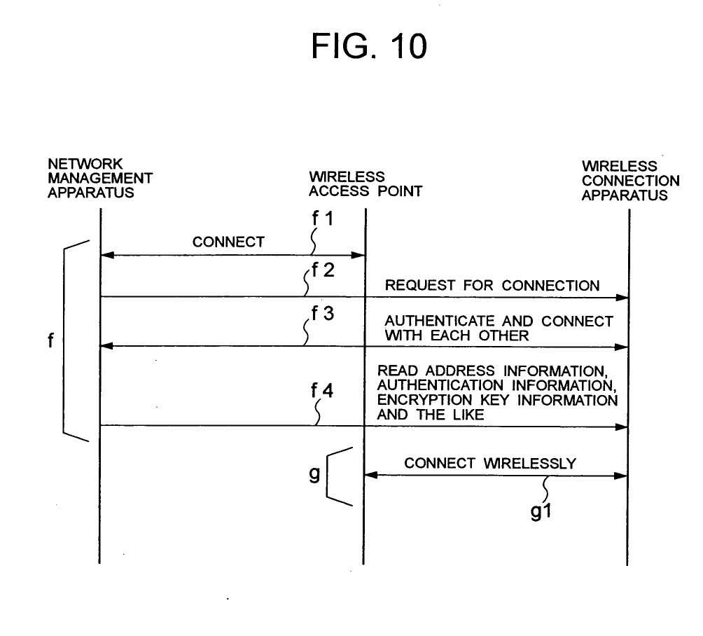

FIG. 10 is a sequence chart showing the operation of the wireless network registration system according to the third embodiment of the present invention. With reference to FIG. 10, the operation of the wireless network registration system according to the third embodiment of the present invention will be described below.

In this case, the wireless connection apparatus 3 is directly moved close with respect to the network management apparatus 1a which manages the address information, the authentication information, the encryption key information and the like, and the writing operation is executed.

When the wireless connection apparatus 3 is moved close to the network management apparatus 1a, the network management apparatus 1a and the wireless connection apparatus 3 are authenticated mutually and connected with each other (f3 in FIG. 10) by the network management apparatus 1a executing the request for connection to the wireless connection apparatus 3 (f2 in FIG. 10). Subsequently, the network management apparatus 1a writes the address information, the authentication information, the encryption key information and the like directly into the wireless connection apparatus 3 (f4 in FIG. 10) [see (f) in FIG. 10]. In this case the network management apparatus 1a and the wireless access point 2 are connected with each other (f1 in FIG. 10).

Accordingly, since the wireless connection apparatus 3 may complete the registration setting and the authentication with respect to the wireless access point 2 by means of the various information written from the network management apparatus 1a, it is registered and connected to the wireless network 100 (gl in FIG. 10) [see (g) in FIG. 10].

Thus, in the third embodiment, since the network management apparatus 1a has the IC card reader-writer unit 14, it is possible to directly write and set the address information, the authentication information, the encryption key information and the like, which are required for connecting to the wireless network 100, with respect to the wireless connection apparatus 3, directly from the network management apparatus 1a without using the IC card reader-writer apparatus 4.

Though the present invention describes the wireless network registration system, it is also applicable to other networks such as a wired network (for example, a home LAN and the like).

1. A wireless network registration system for registering a wireless connection apparatus with a wireless network, comprising:
a network management apparatus for managing setting information on said wireless connection apparatus; and
means passing said setting information in said network management apparatus to said wireless connection apparatus by means of a non-contact type IC card interface.

2. The wireless network registration system according to claim 1, wherein said means passing said setting information is included in an IC card reader-writer apparatus provided independently from said network management apparatus and said wireless connection apparatus.

3. The wireless network registration system according to claim 2, wherein means acquiring a write-setting format of said wireless connection apparatus via the Internet is included in said IC card reader-writer apparatus, and said IC card reader-writer apparatus writes said setting information to said wireless connection apparatus based on said write-setting format.

4. The wireless network registration system according to claim 1, wherein said means passing said setting information is included in said network management apparatus.

5. The wireless network registration system according to claim 1, wherein said setting information includes at least address information, authentication information and encryption key information, which will be required when said wireless connection apparatus is to be registered and connected to said wireless network.

6. A wireless network registration method for registering a wireless connection apparatus with a wireless network, wherein setting information stored in a network management apparatus for managing said setting information on said wireless connection apparatus is passed to said wireless connection apparatus by means of a non-contact type IC card interface.

7. The wireless network registration method according to claim 6, wherein the passing of said setting information is executed by means of an IC card reader-writer apparatus provided independently from said network management apparatus and said wireless connection apparatus.

8. The wireless network registration method according to claim 7, wherein said IC card reader-writer apparatus acquires a write-setting format of said wireless connection apparatus via the Internet, and writes said setting information to said wireless connection apparatus based on the write-setting format.

9. The wireless network registration method according to claim 6, wherein the passing of said setting information is executed by said network management apparatus.

10. The wireless network registration method according to claim 6, wherein said setting information includes at least address information, authentication information and encryption key information, which will be required when said wireless connection apparatus is to be registered and connected to said wireless network.
